(19) United States
(12) Patent Application Publication
(10) Pub. No.: US 2009/0111894 A1
(43) Pub. Date: Apr. 30, 2009

(54) Method of Preventing Microbial Growth

(76) Inventors: Arie Pieter Bos, Vlaardingen (NL); Peter van den Enden, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/084,853

(22) PCT Filed: Oct. 19, 2006
(86) PCT No.: PCT/EP2006/010133

§ 371 Date: May 12, 2008

(30) Foreign Application Priority Data
Nov. 24, 2005 (EP) 05077697.0

(51) Int. Cl. A01N 35/00; A23L 3/34; A01P 1/00

(52) U.S. Cl. 514/693; 426/335

(57) ABSTRACT

There is provided a method of preventing microbial growth in an article, such as a consumer product or packaging material, whereby said article is treated with an effective amount of hydroxyacetaldehyde.

### TECHNICAL FIELD

The present invention relates generally to a method of preventing microbial growth, especially on articles such as consumer products or packaging material. More particularly, it relates to the use of hydroxyacetaldehyde to prevent microbial growth in food products and home and personal care products, such as soap bars, cosmetics, and pharmaceutical preparations.

### BACKGROUND OF THE INVENTION

The growth of microbes such as bacteria or moulds in consumer products or packaging materials is generally felt to be undesirable. The presence of food spoilage organisms and pathogens in food products is a major concern to the food processing industry, government regulatory agencies, and food consumers. The use of anti-microbial agents or preservatives plays an important part in current food preservation techniques.

There exist a large number of different compounds that are used as preservatives in the food industry. For example, sorbates, benzoates, organic acids and combinations thereof have been used, for example in dilute juice beverages, to provide some degree of microbial inhibition. At levels effective to inhibit microbial growth, some of these preservatives can contribute off-flavours to dilute juice beverages. Accepted usage levels for potassium sorbate are in the range of from about 200 to about 3,000 ppm. Typically, potassium sorbate is included in dilute juice beverages at levels far above the effective minimum to ensure antimicrobial activity. However, at the higher end of this accepted usage range, potassium sorbate can contribute off-flavours to dilute juice beverages.

In addition, potassium sorbate is not effective against certain yeasts that can be present in beverage processing plants. Of particular concern is Zygosaccharomyces bailii.

Yeast and mould inhibitors such as natamycin have been found to be particularly effective against yeasts such as Zygosaccharomyces bailii. See Shirk & Clark, “The Effect of Pimaricin in Retarding the Spoilage of Fresh Orange Juice,” Food Technology, 1963, p 108. Natamycin is also effective against a variety of other saprophytic and parasitic fungi and yeasts. See also U.S. Pat. No. 3,892,850. However, natamycin is rather unstable, when it is used in solution. Inactivation of natamycin by light, peroxides or oxygen proceeds at the fastest rate in solution or suspension. For example, an aqueous solution of 6 mcg/ml of natamycin becomes microbiologically inactive after twenty-four hour exposure to light. Natamycin is also sensitive to heavy metals, and can lose up to 75% of its effectiveness in four or five hours in the presence of these heavy metals. In addition, natamycin is not effective against bacteria.

Dialkyl dicarbonates have also been used or suggested for use as yeast inhibitors in wine, ready-to-drink teas, fruit juices, vegetable products, pharmaceutical products, beer and the like. See also U.S. Pat. No. 3,979,524 and U.S. Pat. No. 2,910,400 (also referred to as “pyrocarbonic acid esters”). Dialkyl dicarbonates provide a very effective initial “kill” of any micro-organisms in the just formulated single strength beverage. However, the dialkyl dicarbonate is rapidly hydrolised by aqueous systems such as dilute juice beverages shortly after addition. As the concentration of dialkyl dicarbonate decreases, it soon becomes ineffective to kill microorganisms that might be introduced later during processing into the beverage. See Ough, “Dimethyl-dicarbonate and Diethyldicarbonate” Antimicrobials in Foods, 193, Marcel Dekker, pp. 343-368.

The prior art teaches several different carboxylic acids that are generally useful in suppressing the growth of fungi, bacteria, moulds, and the like. For instance, U.S. Pat. No. 2,154,449 teaches the use of aliphatic C₃-C₁₂-carboxylic acids and their salts as mould inhibitors in food compositions.

U.S. Pat. No. 4,002,775 teaches a food grade microbicidal composition having a monoester with a C12 aliphatic fatty acid as its primary microbicide. U.S. Pat. No. 1,772,975 teaches the use of lactic acid, acetic acid, or combinations thereof, as antiseptics at properly adjusted pH levels.

Other references also disclose the use of fatty acids for the suppression of fungi, bacteria, mould and the like. For exempla, Kabara, J., Medium-chain Fatty Acids and Esters as Antimicrobial Agents, Cosmetic and Drug Preservation, p 275-304, 1984, teaches the use of C₆-C₂₂ saturated and unsaturated fatty acids as antimicrobials.

Kenney, D., Cosmetic Formulas Preserved With Food-Grade Chemicals, Cosmetics and Toiletries, Part 1, Vol. 97, Pgs. 71-76 (1982) and Kabara, J. and Wernette, C., Cosmetic Formulas Preserved with Food-Grade Chemicals, Cosmetics and Toiletries, Part II, Vol. 97, Pgs. 77-84 (1982) teaches the use of monoglyceride emulsifier, food-grade phenols and a chelator in the preservation of cosmetics. Kabara, J., A New Preservative System For Food, Journal of Food Safety, Volume 4, Pgs. 13-25 (1982) teaches the use of monolaurin, a food grade phenolic, and a chelator as an antimicrobial for the preservation of food. Branan, A. and Davison, P. Antimicrobials in Foods, Marcel Dekker, New York 1983, Pgs. 109-140 teaches the use of saturated, unsaturated and esters of fatty acids as antimicrobials and the use of these compounds for food preservation. Kabara, J., Fatty Acids and Derivatives as Antimicrobial Agents-A Review, AOCS Monograph No. 5, p 1-14 (1978) teaches the use of saturated, unsaturated and esters of fatty acids as antimicrobials and the use of these compounds for permeating microorganism cellular membranes for killing the microorganism.

It has been recently suggested that the use of certain food grade polyphosphates, especially sodium hexametaphosphate, can enhance the potency of preservatives, such as potassium sorbate, when the preservative is used at lower levels in dilute juice beverages. See U.S. Pat. No. 5,431,940 which discloses the use of polyphosphates, such as sodium hexametaphosphate, with sorbate preservatives, such as potassium sorbate, in dilute juice beverages having relatively low water hardness. However, inclusion of these polyphosphates can present problems in beverages fortified with calcium or containing proteins, especially milk proteins such as the caseins and albumins. The inclusion of polyphosphates at levels sufficient to potentiate the preservative will also sequester any calcium and milk proteins present and precipitate out the resulting complexes.

However, the addition of these additives has several disadvantages. The addition of antimicrobials may adversely effect the taste of the food composition. With certain additives, the amount of the additive which may be employed in a food composition may be limited by government regulations. And while many agents are useful in certain environments, certain additives may have a narrow spectrum of micro-organism activity and type of foods it may be employed with.

In addition, the presence of pathogenic organisms in foods has led to numerous product recalls, product losses, and considerable negative publicity to the food industry.

U.S. Pat. No. 5,573,800 and U.S. Pat. No. 5,573,801 provide an antimicrobial solution that includes nisin and/or pediocin along with a chelator, and processes for using the antimicrobial solution to treat the surface of foods by applying the composition to the entire surface of the food. In certain embodiments, the antimicrobial solution is contained on packaging films which are applied to foods. The antimicrobial solution is deposited on the surface by spraying, dipping, mixing, or by impregnating or coating the antimicrobial agent onto a food casing.

Accordingly, there is still a need for a method of preventing microbial growth on articles, such as consumer products or packaging material, which method is safe, effective and which overcomes these disadvantages. Furthermore, it is desirable to provide alternative methods of preventing microbial growth, because this increases the probability that an acceptable method can be used in a specific situation.

We have now surprisingly found that these and other objects of the invention may be achieved by the method of preventing microbial growth according to the present invention, which is characterised in that the article is treated with an effective amount of hydroxyacetaldehyde.

The method provides a simple and particularly efficient method for controlling microbial contamination of food products or other consumer goods. Furthermore, the method of current invention provides a simple yet effective method for preventing microbial growth on surface of the packaging material of the consumer goods, especially when the packaging material is corrugated board.

Hydroxyacetaldehyde is known in the food industry as a browning agent. WO-A-91/14379 (Unilever) discloses aqueous solutions comprising precipitated hydroxyacetaldehyde, which are useful for browning foodstuffs. WO-A-01/97625 (Unilever) discloses a sprayable emulsion for enhancing browning of foodstuffs, comprising an oil phase, a water phase and hydroxyacetaldehyde as a browning agent, characterised in that the emulsion is an oil-in-water emulsion and the emulsion comprises
an oil phase, in an amount of 5 to 80% by weight,
a water phase, in an amount of 20 to 95% by weight,
a browning agent, dissolved or dispersed in the water phase
an emulsifier.

Furthermore, Holey and Patel (“improvement in shelf-life and safety of perishable foods by plant essential oils and smoke antimicrobials”, Food Microbiology 22 (2005) 273-292) disclose the use of aromatic and phenolic compounds from wood smoke for the safe extension of perishable foods shelf-life. The present inventors have found that hydroxyacetaldehyde is an ingredient of some types of Smokez™, an artificial smoke flavour.

### DEFINITION OF THE INVENTION

In a first aspect, the present invention relates to a method of preventing microbial growth, whereby an article is treated with an effective amount of hydroxyacetaldehyde.

In a second aspect, the invention relates to the use of hydroxyacetaldehyde as anti-microbial agent in a consumer product.

In a third aspect, the invention relates to an antimicrobial composition comprising hydroxyacetaldehyde and a carrier.

### DETAILED DESCRIPTION OF THE INVENTION

In the first aspect of the present invention, an article is treated with an effective amount of hydroxyacetaldehyde to prevent microbial growth. Hydroxyacetaldehyde, which can also be referred to as Glycolaldehyde or 2-hydroxyethanal, is a small organic molecule having the empirical formula C₂H₄O₂. It has a Molecular Weight of 60.052 and its structural formula is:

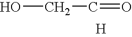

Hydroxyacetaldehyde is a colourless compound having a melting point of 97° C. Hydroxyacetaldehyde is commercially available from fine chemicals suppliers such as FLUKA, SIGMA, etc.

The consumer products treated in accordance with the present invention comprise a hydroxyacetaldehyde. Examples of suitable consumer products are food products and home- or personal care products. Suitable food products are for instance beverage products such as tea, and including dairy products, vegetables, etc. Examples of suitable home- or personal care products are soap bars, shampoo, deodorants and perfumes. Furthermore, hydroxyacetaldehyde can be used to treat packaging material, such as corrugated board, to prevent or minimise the load of microorganisms.

Hydroxyacetaldehyde is not only capable inhibiting the growth of a large number of microorganisms, it was surprisingly found that it can even kill a number of spore-forming organisms.

The articles can also be treated with a combination of hydroxyacetaldehyde preservative and other preservatives, such as sorbate preservative, are at levels below the taste threshold for each of these antimicrobials but at levels sufficient such that the combination is effective against e.g. food spoilage microorganisms.

The hydroxyacetaldehyde antimicrobial is very useful in food and beverage products including dairy products such as cheese, milk, sour cream, yogurt, butter, margarine, ice cream, food and beverage products containing dairy or milk solids and proteins such as salad dressings, creamers, ready-to-spread frosting products, mayonnaise, wines, juices, purees, processed meat products such as sausages, hot dogs, and uncooked fermented manufactured meat products. It can also be used in other acidified food and beverage products (i.e., having a pH of less than about 4.6), high water activity (i.e., greater than about 0.85 aw) and the like, that are susceptible to food spoilage microorganisms.

According to the present invention, the article is treated with hydroxyacetaldehyde in powder form or in the form of a solution of hydroxyacetaldehyde, preferably of an aqueous solution of hydroxyacetaldehyde.

The present invention further relates to a process for treating articles, in particular food products such as beverages, which are normally susceptible to food spoilage microorganisms, with hydroxyacetaldehyde. This process comprises the steps of:
(a) forming a beverage concentrate comprising: a concentrate of a beverage normally susceptible to food spoilage microorganism; and
(b) adding a source of water to the beverage concentrate in an amount sufficient to provide a single strength beverage;
(c) substantially uniformly dispersing hydroxyacetaldehyde in the single strength beverage in an amount sufficient to provide from about 30 to about 1% thereof.

Beverages, including dilute juice beverages, beverages containing tea solids, and beverages containing milk solids, treated with hydroxyacetaldehyde are stable against microbial growth at ambient temperatures and are especially resistant to the growth of common food spoilage yeasts, including Zygosaccharomyces bailii. Because the various components of the antimicrobial combination are be present at levels below their taste threshold, off-flavours are not contributed by this antimicrobial combination. Beverages treated with hydroxyacetaldehyde can also be formulated with calcium or other nutrient minerals, as well as milk solids. Beverages, especially dilute juice beverages, treated with hydroxyacetaldehyde also do not require refrigeration during transportation and storage.

As used herein, “microbial proliferation” means a 100 fold increase or greater in the number of beverage spoilage microorganisms in a beverage after an initial contamination level of about 10 cfu (colony forming units)/ml.

All amounts, parts, ratios and percentages used herein are by weight, unless otherwise specified.

To provide resistance to microbial growth, food products are typically treated with from about 2 to about 10,000 ppm, preferably from about 1 to about 1,000 ppm, more preferably from about 2 to about 100 ppm hydroxyacetaldehyde.

The antimicrobial compound of the present invention, hydroxyacetaldehyde, may also be used in combination with other antimicrobial compounds such as weak acids: sorbic acid, benzoic acid, acetic acid, lactic acid, citric acid etc. Peptides can also be used, like nisin, natamycin, etc.

Dialkyl dicarbonates (also referred to as “pyrocarbonic acid esters”) are also suitable for use in the present invention and have been suggested for use as yeast inhibitors in wine, ready-to-drink teas, fruit juices, vegetable products, pharmaceutical products, beer and the like. See U.S. Pat. No. 3,936,269 and U.S. Pat. No. 3,972,524.

Potassium sorbate is particularly preferred for use in the present invention, especially for dilute juice beverages and other beverages products requiring good water solubility.

Hydroxyacetaldehyde is effective against yeasts, fungi, grain-negative and gram-positive organisms. The critical component of the compositions of the present invention, hydroxyacetaldehyde, is added individually directly into the food composition, cosmetics, drugs, or the like during the manufacturing processing in any convenient order. After addition of the components, the substances are mixed thoroughly so as to uniformly distribute the composition throughout the substance. Once the composition is uniformly distributed in the substance, the substance will be enhanced with antimicrobial properties. However, a composition of the present invention may be prepared as an additive composition prior to addition to the final preserved food, cosmetic, drug, etc. The additive is then added directly to the food, drug or the like.

When tea solids are included, the beverages of the present invention can comprise from about 0.01 to about 1.2%, preferably from about 0.05 to about 0.8%, by weight of tea solids. The term “tea solids” as used herein means solids extracted from tea materials including those materials obtained from the genus Camellia including C. sinensis and C. assaimica, for instance, freshly gathered tea leaves, fresh green tea leaves that are dried immediately after gathering, fresh green tea leaves that have been heat treated before drying to inactivate any enzymes present, unfermented tea, instant green tea and partially fermented tea leaves. Green tea materials are tea leaves, tea plant stems and other plant materials that are related and which have not undergone substantial fermentation to create black teas. Members of the genus Phyllanthus, Catechu gambir and Uncaria family of tea plants can also be used. Mixtures of unfermented and partially fermented teas can be used.

Ambient display times correspond to the time period during which a food product, such as a beverage product at 20° C. can effectively resist microbial proliferation following a 10 cfu/ml inoculation with food spoilage microorganisms. The term “microbial proliferation” as used herein means a 100 fold increase or greater in the number of food spoilage microorganisms in a food product, after an initial inoculation level of about 10 cfu/ml.

Ambient display times for food products can be determined by the following method. Food products are inoculated with mixed groups of preservative resistant yeast containing at least four separate yeast isolates, including Zygosaccharomyces bailii, and with mixed groups of preservative resistant, acid tolerant bacteria, including Acetobacter species. All yeast and bacteria utilized in the inoculation are previously isolated from preserved fruit juice beverages. Inoculated food products are maintained at 20° C. for 21 days and aerobic plate cultures performed periodically. Aerobic plate counts of both yeast and bacteria populations are performed as described in the Compendium of Methods for the Microbiological Examinations of Foods, American Public Health Association, Washington, D.C. (edited by C. Vanderzant and D. F. Splittstoesser). These plate counts are then used to identify the degree of microbial proliferation in the inoculated beverage.

While the above summarizes the present invention, it will became apparent to those skilled in the art that modifications, variations and alterations may be made without deviating from the scope and spirit of the present invention as described and claimed herein. The invention will now be further illustrated in the following non-limiting examples.

### EXAMPLE 1

The inhibition effect of Hydroxyacetaldehyde was tested in model media at various concentration levels and at 3 different pH's and against various micro-organisms at 30° C.

The medium was Brain Heart Infusion Broth (BHI) or Malt Water. Tested were:
Bacillus subtilus in BHI
Echerichia coli in BHI
Staphylococcus aureus in BHI
Saccharomyces cerevisieae in Malt water
Penicillium crustosum in Malt water

The pH of the media was set in the medium to 4.5 5.0 and 6.0, respectively. Hydroxyacetaldehyde concentrations were: 0, 0.0125, 0.025, 0.05, 0.1, 0.2, and 0.4%. Growth was recorded by an automated Optical Density reader (NEPHELOstar Galaxy of the manufacturer BMG).

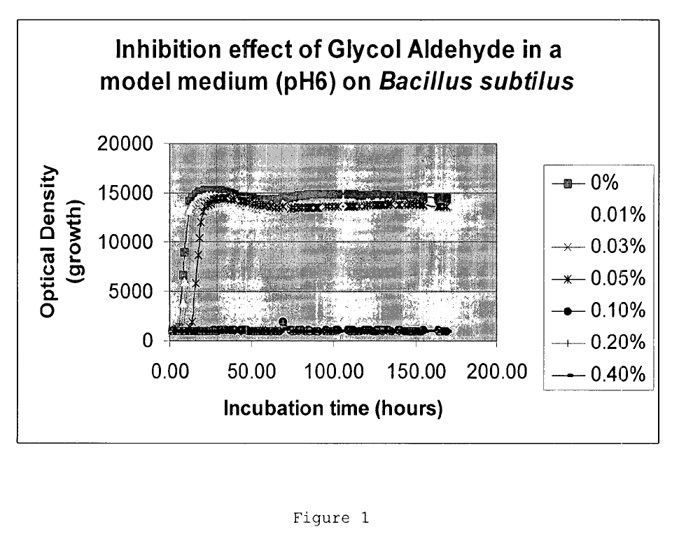

The MIC (Minimal Inhibition Concentration) (%-ages are weight/volume) for the different microorganisms are shown in the following Table:

| pH | 4.5 | 5 | 6 | |
|---|---|---|---|---|
| Bacillus subtilus | 0.1% | 0.1% | 0.1% | (FIG. 1) |
| Echerichia coli | 0.1% | 0.1% | 0.1% | |
| Staphylococcus aureus | 0.05% | 0.05% | 0.05% | |
| Candida parapsilosis | 0.2% | | 0.2% | |
| Penicillium crustosum | 0.1% | | 0.1% | |

It is clear that there was no influence of pH on the MIC value.

### EXAMPLE 2

The inhibition effect of Hydroxyacetaldehyde was tested in Ice Tea at various concentrations, at 2 different pH's and against 2 micro-organisms at 25° C. Tested were:
Zygosaccharomyces bailii
Talaromyces trachyspermus

The medium was Lipton Ice Tea with apple juice. The pH of the medium was set at 4.5 and 6.0, respectively. Hydroxyacetaldehyde concentrations were: 0, 0.0125, 0.025, 0.05, 0.1, 0.2, 0.4 and 0.8%. Growth was recorded by an automated optical density reader NEPHELOstar Galaxy of the manufacturer BMG. The MIC (Minimal Inhibition Concentration) for the different micro-organisms were:

| pH | 4.5 | 6 |
|---|---|---|
| Zygosaccharomyces bailii | 0.8% | 0.8% |
| Talaromyces trachyspermus | 0.1% | 0.1% |

It is clear that there was no influence of pH on the MIC value for the yeast and mould.

### EXAMPLE 3

Contamination with moulds and bacteria is known to be serious problem for corrugated board. Hydroxyacetaldehyde was added to the corrugated board pulp during production to determine if it would be possible to produce a mould-free corrugated board. To prove the production of germ free corrugated board, the next experiment was carried out.

To 40 gram of small pieces of cut corrugated board 300 ml of sterile water was added. This was mixed to form a pulp. This pulp was divided into 3 portions to which 0, 0.5 and 2% hydroxyacetaldehyde was added. The pulp was incubated at 20° C. and after 0, 2, 5 and 22 hours the number of organisms per gram pulp was measured. The reduction factor (cfu at to/cfu at tₙ) was as follows:

| | Bacteria | | | Moulds | | |
|---|---|---|---|---|---|---|
| | Hydroxyacetaldehyde | | | | | |
| Incubation time (hours) | 0 | 0.5 | 2% | 0 | 0.5 | 2% |
| 2 | 0.5 | 3.8 | 7.4 | 1.3 | 20 | >40 |
| 5 | 0.4 | 4.1 | 26.4 | 1.8 | 40 | >40 |
| 22 | 0.25 | 25.5 | >1.4e4 | 5 | >40 | >40 |

It is clear that for bacteria, without Hydroxyacetaldehyde a slow growth occurs and that with 0.5% and 2%, respectively, slow and faster die-off occurs. For moulds a similar effect was observed. However, due to the fact that to was very low, no significant difference was found between the reduction factor at 0.5% or 2% Hydroxyacetaldehyde.

1. Method of preventing microbial growth, whereby an article is treated with an effective amount of hydroxyacetaldehyde.

2. Method according to claim 1, wherein said article is a consumer product or packaging material.

3. Method according to claim 2, wherein said article is a food product.

4. Method according to claim 2, wherein said article is a home or personal care product.

5. Method according to claim 2, wherein said article is packaging carton.

6. Method according to claim 1, wherein a hydroxyacetaldehyde solution of 0.01 to 5% by weight is sprayed onto the article.

7. Method according to claim 1, wherein an amount of 2 to 10,000 ppm of hydroxyacetaldehyde is incorporated into the product.

8. Use of hydroxyacetaldehyde as anti-microbial agent.

9. Use according to claim 8, as anti-microbial agent in a consumer product or packaging material.

10. Use according to claim 8, in food product.

11. Use according to claim 8, in home or personal care product.

12. A shelf-stable food composition, comprising a food stuff employing a safe and effective amount of hydroxyacetaldehyde as preservative.

13. Antimicrobial composition comprising hydroxyacetaldehyde and a carrier, wherein said carrier comprises at least one component selected from the group consisting of alcohols, water, and mixtures thereof.

14. A composition according to claim 13, wherein the carrier comprises an alcohol selected from the group consisting of propylene glycol, phenoxyethanol, ethanol, and mixture thereof.

15. A composition according to claim 13, wherein the carrier additionally comprises a food-grade surfactant.

16. A composition according to claim 13, wherein said carrier includes a chelating agent, selected from the group consisting of lactic acid and its salts, polyphosphoric acid and its salts, EDTA, citric acid and its salts and mixtures thereof.
